(19) United States
(12) Patent Application Publication
(10) Pub. No.: US 2026/0211618 A1
(43) Pub. Date: Jul. 23, 2026

(54) BINARY NUMBER-BASED COMPUTATION ACCELERATION CIRCUIT

(71) Applicant: Montage Technology, Inc., San Jose, CA (US)

(72) Inventors: Guoheng WEI, San Jose, CA (US); Guoxin CAO, San Jose, CA (US)

(21) Appl. No.: 19/026,475

(22) Filed: Jan. 17, 2025

(51) Int. Cl. G06F 7/493

(52) U.S. Cl. CPC G06F 7/493

(57) ABSTRACT

The present application relates to a binary number-based computation acceleration circuit. The computation acceleration circuit comprises: a pre-processing module for separating an input value Xᵢ into an integer part xᵢₙₜ and a decimal part x_{f}; a lookup table module and a function calculation module coupled to the pre-processing module, wherein the lookup table module is configured to receive the decimal part x_{f} and/or information corresponding to the decimal part x_{f}, and to select a set of parameters from predetermined parameters according to the decimal part x_{f} and/or the information corresponding to the decimal part x_{f}, and the function calculation module is configured to construct an approximation function using the set of parameters selected by the lookup table module to obtain an approximation of 2^{x}^{_{f}}; and a post-processing module coupled to the pre-processing module and the function calculation module, wherein the post-processing module is configured to receive the integer part xᵢₙₜ from the pre-processing module, using a mantissa part of the approximation of 2^{x}^{_{f}} as a mantissa part of an approximation of 2^{X}^{ᵢ}, and using a sum of an exponential part of the approximation of 2^{x}^{_{f}} and the integer part xᵢₙₜ as an exponential part of the approximation of 2^{X}^{ᵢ}; wherein the input value Xᵢ, the approximation of 2^{x}^{_{f}} and the approximation of 2^{X}^{ᵢ} are represented in binary form.

### TECHNICAL FIELD

The present application generally relates to the field of data computation, and more particularly, to a binary number-based computation acceleration circuit.

### BACKGROUND OF THE INVENTION

In modern industrial production, academic research, and daily entertainment, a significant amount of data computation is involved. In application scenarios of data computation, particularly in scenarios where artificial intelligence is employed to process big data, the amount of data and parameters is immense. Accelerating data computation is beneficial for improving computational efficiency, saving time, conserving power resources, and more. However, conventional methods for computation acceleration may undesirably sacrifice a considerable degree of computational accuracy.

Therefore, there is a need for an improved solution for computation acceleration.

### SUMMARY OF THE INVENTION

An objective of the present application is to provide a binary number-based computation acceleration circuit, which can accelerate computation while maintaining high accuracy.

According to an aspect of the present application, a binary number-based computation acceleration circuit is provided. The computation acceleration circuit comprises: a pre-processing module for separating an input value Xᵢ into an integer part xᵢₙₜ and a decimal part x_{f}; a lookup table module and a function calculation module coupled to the pre-processing module, wherein the lookup table module is configured to receive the decimal part x_{f} and/or information corresponding to the decimal part x_{f}, and to select a set of parameters from predetermined parameters according to the decimal part x_{f} and/or the information corresponding to the decimal part x_{f}, and the function calculation module is configured to construct an approximation function using the set of parameters selected by the lookup table module to obtain an approximation of 2^{x}^{_{f}}; and a post-processing module coupled to the pre-processing module and the function calculation module, wherein the post-processing module is configured to receive the integer part xᵢₙₜ from the pre-processing module, using a mantissa part of the approximation of 2^{x}^{_{f}} as a mantissa part of an approximation of 2^{X}^{ᵢ}, and using a sum of an exponential part of the approximation of 2^{x}^{_{f}} and the integer part xᵢₙₜ as an exponential part of the approximation of 2^{x}^{_{f}}; wherein the input value Xᵢ, the approximation of 2^{x}^{_{f}} and the approximation of 2^{X}^{ᵢ} are represented in binary form.

The foregoing general description is an overview of the present application, which may involve simplification, generalization, and omission of details. Therefore, persons skilled in the art should recognize that this section is exemplary and explanatory only, and is not restrictive of the invention in any way. This general description is neither used to identify key or essential features of the claimed subject nor to serve as an aid in determining the scope of the claimed subject.

### BRIEF DESCRIPTION OF DRAWINGS

Through the combination of the following description, the appended claims and the drawings, the above and other features of the present application will be understood more fully and clearly. It should be understood that the drawings referenced herein illustrate only some several embodiments of the content of this application, and thus should not be regarded as limitation of the scope of the present application. The content of the present application will be illustrated more clearly and in detail through the drawings.

FIG. 1 illustrates a diagram of a circuit architecture according to an embodiment of the present application.

FIG. 2 illustrates a diagram of a circuit architecture according to another embodiment of the present application.

FIG. 3 illustrates a flowchart of data processing performed by a pre-processing module according to an embodiment of the present application.

FIG. 4 illustrates a flowchart of data processing performed by a post-processing module according to an embodiment of the present application.

### DETAILED DESCRIPTION OF THE INVENTION

The following detailed description of exemplary embodiments of the application refers to the accompanying drawings that form a part of the description. In the drawings, similar symbols typically represent similar components unless otherwise specified by the context. The illustrative embodiments described in the detailed description, the drawings and the claims are not intended to limit. It should be understood that other embodiments may be employed and other changes may be made without departing from the spirit or scope of the present application. It should be understood that various configurations, substitutions, combinations, and designs of the various aspects of the present application that are generally described and illustrated in the drawings may be made, and all of these are incorporated as part of the present application.

In current industrial production and daily life, there is a substantial demand for data computation, which is typically performed by computers or similar computing devices. At the underlying level of a computer, data is usually represented and calculated in binary form. In binary data computations, base-2 exponential computation is a common type of data computations. For such computations, the present application provides a binary number-based computation acceleration circuit. The computation acceleration circuit can be used to accelerate base-2 exponential computations and other computations that include base-2 exponential computations. For example, the computation acceleration circuit can accelerate computations combining base-2 exponential computations with other computations. It should be understood that if a computation can be approximated as a base-2 exponential computation or as a combination of base-2 exponential computations with other computations, the computation acceleration circuit provided in the present application can also be used to accelerate such computations.

A Softmax computation is taken as an example, which can be approximated as a combination of base-2 exponential computations and other computations. An computation acceleration circuit of the present application is illustrated by taking the acceleration of the Softmax computation as an example. However, it should be understood that the present application is not limited to the implementation on the Softmax computation.

The Softmax computation is a common numerical transformation computation. Specifically, the Softmax computation can be represented by Equation (1). For a vector z containing K elements (K is a positive integer), the Softmax computation can be applied to the elements zᵢ(i∈[1, k]) of the vector z to obtain σ(z)ᵢ. e^{z}^{ᵢ} represents an exponential value of an i-th element of the vector z, and

$${\sum }_{j = 1}^{K} {e}^{{z}_{j}}$$

represent a sum of the exponential values of all elements in the vector z. Those skilled in the art can understand that while the index range for zᵢ is given as [1, K], it may also be [0, K−1] depending on indexing conventions. The index merely identifies each element in the vector z and does not restrict the position of the elements.

$${σ ( z )}_{i} = {e}^{{z}_{i}} / {\sum }_{j = 1}^{K} {e}^{{z}_{j}} \qquad ( 1 )$$

The Softmax computation can be used in multi-class classification problems such as multinomial logistic regression, multinomial linear discriminant analysis, naive Bayes classifiers and neural networks. In multi-class classification problems, a probability of a sample belonging to one of K classes can be computed using the transformation in Equation (1). Typically, in a final layer of a neural network-based classifier, the Softmax computation is used to transform an input vector into probability distributions for various classes. For example, the Softmax computation can be used in classification models for images, text, and big data. Typical classification models include neural network models such as Visual Geometry Group (VGG), Resnet, and Transformer. Additionally, the Softmax computation can be used for weighting functions and/or in other parts of neural networks. Typically, a self-attention module of a Transformer includes Softmax computations to implement weighting. Similarly, other weighting functions or neural networks with attention mechanisms may also include the Softmax computations. The above examples illustrate application scenarios for the Softmax computation. It should be understood that the Softmax computation may also be used for numerical transformations in other data processing methods or in other parts of neural networks. From the perspective of application scenarios, the Softmax computation can be widely applied to the classification of data such as video, images, text, and sound, which is not limited by the present application. For example, in classification problems involving video, image, text, and sound data, the video, image, text, and sound data may be used in specific scenarios, and thus data used in such scenarios may be similar as certain classes in the classification problems. In such cases, the Softmax computation is particularly suitable for emphasizing the high probability of video, image, text, and sound data in the specific scenarios belonging to a specific class.

The specific implementation of the binary number-based computation acceleration circuit of this application for accelerating the Softmax computation will be further described with reference to specific embodiments.

In an embodiment of the present application, the Softmax computation in Equation (1) can be approximated as Equation (2), in which Xᵢ=zᵢ/ln2. Equation (2) approximates a base-e exponential computation into a base-2 exponential computation, which is better adapted to the binary representation and computation of data in computer hardware, and enables the acceleration described later.

$${σ ( z )}_{i} = {2}^{{X}_{i}} / {\sum }_{j}^{K} {2}^{{X}_{j}} \qquad ( 2 )$$

In some embodiments, approximating e^{z}^{ᵢ} as 2^{X}^{ᵢ} can be achieved through a compiler.

In some embodiments, the computation Xᵢ=zᵢ/ln2 can be performed by constant folding technique. In some embodiments, the computation Xᵢ=zᵢ/ln2 can be performed by additional hardware circuits.

As shown in Equation (2), both the numerator and denominator primarily involve the computation of 2^{X}^{ᵢ}, which is a base-2 exponential computation with Xᵢ as the exponent. Therefore, after the Softmax computation is transformed into the base-2 exponential computation, the computation speed depends on the speed of the base-2 exponential computation.

To achieve the base-2 exponential computation acceleration, the present application provides the following circuit structure.

### Circuit Structure

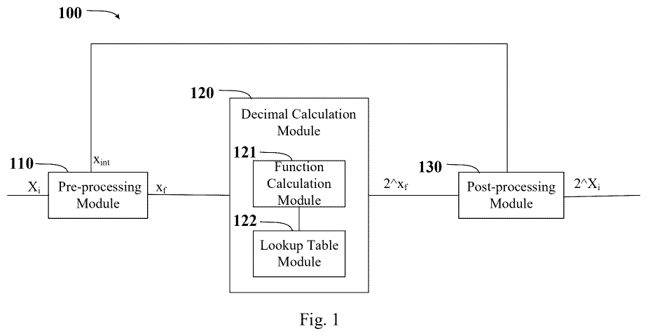

FIG. 1 illustrates a computation acceleration circuit 100 according to one embodiment of the present application.

In some examples, the computation acceleration circuit 100 can be used to accelerate Softmax computations, base-2 exponential computations, or the combination of base-2 exponential computations and other computations.

As shown in FIG. 1, the computation acceleration circuit 100 includes a pre-processing module 110, a function calculation module 121, a lookup table (LUT) module 122, and a post-processing module 130. The pre-processing module 110 is used to separate an input value Xᵢ into an integer part xᵢₙₜ and a decimal part x_{f}, i.e., Xᵢ=xᵢₙₜ+x_{f}. A value of the decimal part x_{f} has a range of 0≤x_{f}<1. The integer part xᵢₙₜ is transmitted from the pre-processing module 110 to the post-processing module 130, which is coupled to the pre-processing module 110. The decimal part x_{f} and/or information corresponding to the decimal part x_{f} is transmitted from the pre-processing module 110 to the function calculation module 121 which is coupled to the pre-processing module 110. The decimal part x_{f} and/or information corresponding to x_{f} is also transmitted from the pre-processing module 110 to the LUT module 122 which is coupled to the pre-processing module 110. In one embodiment, predetermined parameters are written into the lookup table module 122. The lookup table module 122 selects parameters from the stored predetermined parameters based on its input, and outputs selected parameters to the function calculation module 121. The function calculation module 121 constructs an approximation function using the parameters output by the lookup table module 122, and performs calculations on the decimal part x_{f} and/or information corresponding to the decimal part x_{f} using the approximation function to obtain an approximation of 2^{x}^{_{f}}. The approximation of 2° F. is transmitted to the post-processing module 130. Since 2° F. and 2^{X}^{ᵢ} share the same mantissa part when represented in binary form, the post-processing module 130 uses the mantissa part of the approximation of 2^{x}^{_{f}} as a mantissa part of the approximation of 2^{X}^{ᵢ}. The post-processing module 130 can add the integer part xᵢₙₜ to the exponential part of the approximation of 2^{x}^{_{f}}, which means summing the exponential part of the approximation of 2^{x}^{_{f}} and the integer part xᵢₙₜ, to obtain an exponential part of the approximation of 2^{X}^{ᵢ}. Finally, an approximation of 2^{X}^{ᵢ} is obtained. In brief, by designing a circuit that separates the input value Xᵢ into an integer part and a decimal part for computation, the complexity of the computation is reduced, and the computation speed is improved.

There can be multiple variations in the specific structural arrangements among the function calculation module 121, the LUT module 122, and the pre-processing module 110, as long as there is a direct or indirect coupling relationship among the pre-processing module 110, the function calculation module 121, and the LUT module 122. In some embodiments, as shown in FIG. 1, the function calculation module 121 and the LUT module 122 can be directly coupled with each other, and form a decimal calculation module 120. The pre-processing module 110 is directly coupled to the decimal calculation module 120. In other embodiments, the pre-processing module 110, the function calculation module 121 and the LUT module 122 can be independent of each other and directly coupled to one another. In other embodiments, the pre-processing module 110 can be directly coupled to only one of the function calculation module 121 and the LUT module 122, while the function calculation module 121 and the LUT module 122 are directly coupled to each other.

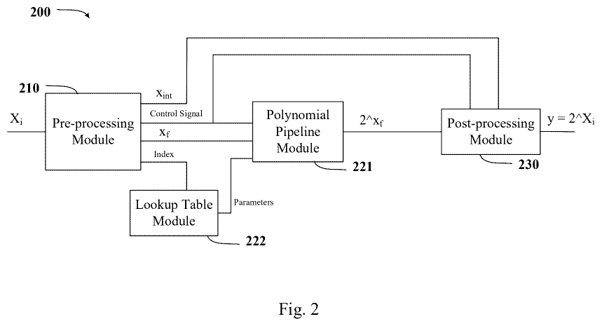

FIG. 2 illustrates an exemplary computation acceleration circuit 200 of the computation acceleration circuit 100 shown in FIG. 1 according to another embodiment of the present application.

As shown in FIG. 2, the computation acceleration circuit 200 is similar to the computation acceleration circuit 100 shown in FIG. 1 in the overall architecture. In particular, in the computation acceleration circuit 200, a function calculation module is implemented as a polynomial pipeline module 221. An approximation function is a polynomial function. Parameters of the polynomial function are selected by a LUT module 222 from predetermined parameters according to the information corresponding to a decimal part x_{f}, and then output to the polynomial pipeline module 221 to construct the approximation function and perform subsequent computations.

The specific details of each module of the computation acceleration circuit 200 are described as follows.

### Pre-Processing Module

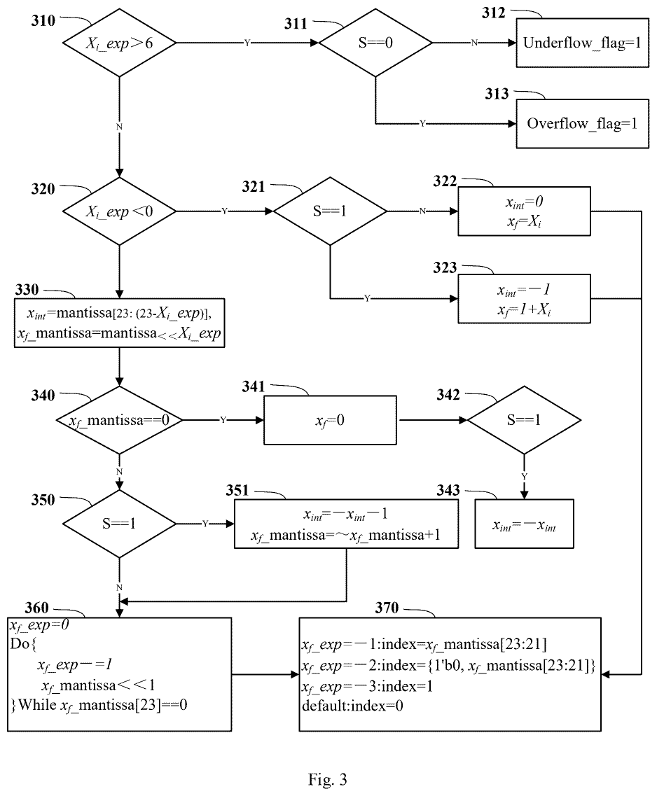

A pre-processing module 210 separates an input value Xᵢ into an integer part xᵢₙₜ and the decimal part x_{f}, i.e., Xᵢ=xᵢₙₜ+x_{f}. A value of the decimal part x_{f} has a range of 0≤x_{f}<1. The process of separating the value Xᵢ by the pre-processing module 210 may employ various methods. FIG. 3 illustrates a separation process, which will be specifically explained below.

In some embodiments, the pre-processing module 210 can quantize the decimal part x_{f} to obtain a corresponding quantized value referred to as an index. The index indicates the specific sub-interval within the range [0,1) in which the decimal part x_{f} is located. As shown in FIG. 2, the index can be transmitted to a LUT module 222 coupled to the pre-processing module 210. The LUT module 222 can select specific parameters from stored predetermined parameters based on the index and further transmit the selected parameters to the polynomial pipeline module 221. The polynomial pipeline module 221 computes a polynomial function using the selected parameters to obtain an approximation of 2^{x}^{_{f}}.

It should be understood that quantization of the decimal part x_{f} transforms continuous or numerous discrete values into a limited set of quantized values or indexes. During the quantization, the value range of the decimal part x_{f}, i.e., [0, 1), can be discretized into multiple equal-length sub-intervals. It should be understood that the larger the number of discretized sub-intervals is, the finer the division of the value range of the decimal part x_{f} is, and the more accurate the approximation of 2^{x}^{_{f}} is. However, an increase in the number of sub-intervals may increase the burden of storage and computation. Optionally, for the convenience of subsequent encoding and to enable the encoding of the sub-intervals in binary form, the number of discretized sub-intervals of the value range of the decimal part of may be 2ⁿ, where n is a positive integer. In this way, each of the 2ⁿ sub-intervals may correspond to an n-bit binary code.

Optionally, for example, the number of intervals may be set to 23=8. Tests conducted by the inventors reveal that dividing the range of the decimal part into 8 intervals achieves both high computational efficiency and sufficient approximation accuracy for 2^{x}^{_{f}}. Specifically, the range of the decimal part x_{f}, i.e., [0, 1), can be evenly divided into 8 sub-intervals. For a j-th sub-interval in the 8 sub-intervals, its value range is

$$[ \frac{j}{8} , \frac{j + 1}{8} ) .$$

j is an integer and satisfies 0≤j<8. The 8 sub-intervals can be represented by a 3-bit binary code, i.e., 000 to 111. For instance, when the decimal part x_{f} is within [0, ⅛), j can be defined as 0, i.e., j=0, and the associated quantized code or the index is 000. In another embodiment, the range [0, 1) may be divided into 24=16 sub-intervals. For the j-th sub-interval, its range is

$$[ \frac{j}{16} , \frac{j + 1}{16} ) .$$

j is an integer and 0≤j<16. The 16 sub-intervals correspond to a 4-bit binary code ranging from 0000 to 1111. It is understood that if the decimal part x_{f} itself is represented in binary form, this binary representation may serve as the quantized code or the index.

In some embodiments, the sub-interval to which the decimal part x_{f} belongs can be determined based on the value of the decimal part x_{f}. Specifically, x_{f} can be multiplied by 2n, and the product is rounded down to identify the sub-interval to which x_{f} belongs. In an example where the range of the decimal part x_{f}, i.e., [0, 1), is divided into 8 sub-intervals (i.e., n=3), when x_{f}=0.3, then 23×0.3=2.4, which can be rounded down to 2, indicating that x_{f} belongs to the second sub-interval with the quantized code/index 010. It should be understood that other methods suitable for converting the decimal part x_{f} into quantized code/index can also be employed. The methods are not limited to the aforementioned examples.

In some embodiments, as shown in FIG. 2, the pre-processing module 210 can also generate and output extra control signals (“ctrl_signal”). The control signals may indicate predetermined special cases that may occur during data processing. The special cases may correspond to predictable computation results and thus can be provided with extra computation paths. The extra computation paths can serve as bypass calculations for the function calculation module to further improve computational efficiency. For example, the special cases may include a case that 2^{X}^{ᵢ} is expected to overflow and a case that 2di is expected to underflow. And the overflow and underflow can each be indicated by a 1-bit indication signal. And the special cases may include a case that Xᵢ is 0, which can be indicated by a 1-bit indication signal. The cases of overflow of 2^{X}^{ᵢ}, underflow of 2^{X}^{ᵢ} and Xᵢ being 0 are predictable and avoidable cases. In some embodiments, the control signals can be configured as a 3-bit signal, which can respectively indicate cases that 2^{X}^{ᵢ} may overflow (“is_of”, e.g. the control signal is “001”), 2^{X}^{ᵢ} may underflow (“is_uf”, e.g. the control signal is “010”), and Xᵢ is 0 (“is_zero”, e.g. the control signal is “100”). The sequence of the 3-bit signal may be adjusted as needed. It should be understood that more special cases may also be indicated by the control signals depending on specific circumstances.

FIG. 3 illustrates a flowchart of data processing performed by the pre-processing module 200 shown in FIG. 2 according to an embodiment of the present application. The following description is only an example that the computation acceleration circuit where the pre-processing module 210 is located adopts an fp32 system. According to the IEEE754 standard, in the fp32 system, the representation format of a single-precision floating-point number is “1 sign bit, 8 exponent bits, 23 mantissa bits”, but the present application is not limited thereto.

Specifically, the pre-processing module 210 can first determine whether the received data belongs to the special cases (the special cases can be predetermined) and generate a control signal indicating one of the special cases. For example, the control signal may indicate 1 when the received data belongs to predetermined special cases, and indicate 0 when the received data does not belong to predetermined special cases. Specifically, for the special case of overflow or underflow, the pre-processing module 210 can determine in step 310 whether the value of exponent bits (Xᵢ_exp) of Xᵢ is greater than 6. When Xᵢ_exp>6, Xᵢ≥128, 2^{X}^{ᵢ} exceeds the numerical range that the fp32 system can represent, and it is expected that 2^{X}^{ᵢ} may overflow. In step 311, the pre-processing module 210 can further determine whether an overflow or an underflow occurs based on the sign bit S of Xᵢ. When the sign bit S of Xᵢ is 0, it represents that Xᵢ is a positive value. Xᵢ being a positive value indicates an overflow, and as shown in step 313, the overflow indication signal is set to 1. Conversely, when the sign bit S of Xᵢ is not 0, it represents that Xᵢ is a negative value. Xᵢ being a negative value indicates an underflow, and as shown in step 312, the underflow indication signal is set to 1. Those skilled in the art can understand that setting a resolution mechanism according to the conditions of overflow and underflow helps to enhance the robustness of the system and improve the processing speed for overflow conditions.

Those skilled in the art can understand that in systems using other data types, such as fp64, fp16, tf32, bf16, etc., the threshold for determination in step 310 can be adaptively adjusted according to the data type. For example, when the fp64 data type is used, the threshold can be set to 9; when Xᵢ_exp>9,Xᵢ≥1024, 2^{X}^{ᵢ} exceeds the numerical range that the fp64 system can represent, which means an overflow or underflow has occurred.

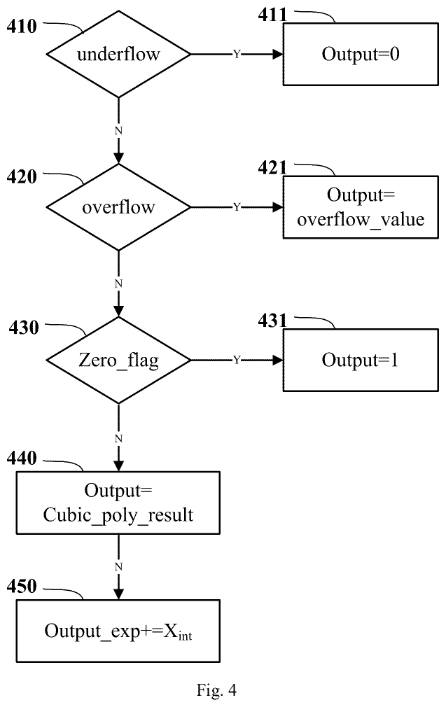

As mentioned above, in some embodiments, the pre-processing module 210 may also determine whether Xᵢ is 0. When it is determined that Xᵢ is 0, the value of 2^{X}^{ᵢ} can be directly determined as 1. For this special case, the indication signal (“is_zero”) for Xᵢ being 0 (such as the Zero_flag signal in FIG. 4) can be set to 1 for processing by the post-processing module 230. The flowchart shown in FIG. 3 does not show a determination step of whether Xᵢ is 0, which can be set at any position in the flowchart shown in FIG. 3. The determination step may be set before step 310, or it may be set between steps 310 and 320.

When it is determined by the pre-processing module 210 that 2Xᵢ does not belong to the special cases, Xᵢ can be further separated into the integer part xᵢₙₜ and the decimal part x_{f}. As shown in step 320 of FIG. 3, it is first determined whether Xᵢ is within a range of (−1, 1). When Xᵢ is within the range of (−1, 1), the pre-processing module 210 can determine the integer part and the decimal part according to the sign bit S, and further determine the index. Therefore, this case can be processed separately. As shown in steps 320 to 323, it is first determined in step 320 whether the exponent bits of Xᵢ are less than 0. When the exponent bits of Xᵢ are less than 0, then Xᵢ is within the range of (−1, 1). Further, in step 321, it is determined whether the sign bit S of Xᵢ is 1. When the sign bit S of Xᵢ is not 1, which means that Xᵢ is a positive value, Xᵢ is within the range of (0, 1). Then in step 322, Xᵢ can be separated into the integer part xᵢₙₜ of 0, and the decimal part x_{f} which is Xᵢ itself. Conversely, When the sign bit S of Xᵢ is 1, which means that Xᵢ is a negative value, Xᵢ is within the range of (−1, 0). Then in step 323, Xᵢ can be separated into the integer part xᵢₙₜ of −1 and the decimal part x_{f} of (1+Xᵢ). After step 322 or 323, step 370 can be directly performed to determine the index corresponding to the decimal part. The specific description of step 370 will be given below.

It can be understood that when it is determined in step 320 that Xᵢ is not within the range of (−1, 1), then step 330 and the subsequent steps can be performed. Firstly, in step 330, in order to obtain the integer part xᵢₙₜ, a truncation operation can be performed on a mantissa part of the input value Xᵢ according to an exponential part of the input value Xᵢ in the binary representation of Xᵢ. Specifically, as shown in step 330, the truncation operation can be performed according to xᵢₙₜ=mantissa [23:(23-Xᵢ_exp)], which means the 23rd bit (a highest bit) to the (23-Xᵢ_exp)-th bit of the mantissa part are truncated as the integer part. It should be noted that in the fp32-bit system, the complete mantissa part is composed of 23 truncated mantissa bits and 1 leading hidden bit, and the mantissa part is actually 24 bits. The mantissa part mentioned in the present application refers to the complete mantissa part, and the 23rd bit of the mantissa part is the leading hidden bit. For example, if Xᵢ_exp=1, then the 23rd to 22nd bits of the mantissa part are truncated as the integer part. To obtain the decimal part, the mantissa part of Xᵢ can be first shifted according to the exponential part of Xᵢ to obtain the mantissa part of the decimal part x_{f}. As shown in step 330, the shift operation can be performed according to x_{f}_mantissa=mantissa<<Xᵢ_exp. The mantissa part of Xᵢ is shifted left by X_exp bits as the mantissa part of the decimal part x_{f}. “<<” is the shifting left symbol. During the shifting left operation, the lower bits can be filled with 0. In one embodiment, the shift operation can be implemented by a shift register.

Then, in some embodiments, step 340 is performed to determine whether the mantissa part x_{f}_mantissa of the decimal part x_{f} is 0. If x_{f}_mantissa is 0, a simplified operation can be performed in step 341 to set the decimal part x_{f} as 0. After that, step 342 is performed to determine whether the sign bit S is 1. If the sign bit S is 1, it means that Xᵢ is a negative value. Then the integer part xᵢₙₜ obtained in step 330 needs to be reversed. As shown in step 343, xᵢₙₜ=−xᵢₙₜ. If it is determined in step 340 that x_{f}_mantissa is not 0, then step 350 is performed.

In step 350, it can be determined whether the sign bit S is 1. If the sign bit S is 1, then step 351 is performed to complement the integer part xᵢₙₜ obtained in step 330 and the mantissa part x_{f}_mantissa of the decimal part x_{f} to convert them into respective negative representations. As shown in step 351, for the integer part xᵢₙₜ, first the integer part xᵢₙₜ obtained in step 330 is reversed and then decreased by 1, that is, xᵢₙₜ=−xᵢₙₜ−1. For the mantissa part x_{f}_mantissa of the decimal part x_{f}, first a bitwise reversion (reversing each bit, that is, change 0 to 1 and 1 to 0) is performed on the mantissa part x_{f}_mantissa of the decimal part x_{f} obtained in step 330, and then 1 is added to obtain the adjusted mantissa part x_{f}_mantissa of the decimal part x_{f}. After that, step 360 can be performed. When it is determined in step 350 that the sign bit S is not 1, then step 360 is performed directly.

In step 360, first the exponential part x_{f}_exp of the decimal part is defined as 0. After that, a do-while loop is performed. In the loop, first x_{f}_exp is decreased by 1, and then x_{f}_mantissa is shifted left by 1 bit. Then whether the 23rd bit of x_{f}_mantissa is 0 is determined. If it is 0, the do-while loop is executed until the 23rd bit of x_{f}_mantissa is not 0. Then step 370 is performed.

In step 370, the index can be determined according to the final value of x_{f}_exp in step 360. Four cases are listed in step 370: when x_{f}_exp is −1, the index is the 23rd to 21st bits of the current value of x_{f}_mantissa; when x_{f}_exp is −2, the index is equal to {1′b0, x_{f}_mantissa [23:22]}, that is, a 3-bit binary number formed by 0 and the 23rd to 22nd bits of the current value of x_{f}_mantissa. For example, if the 23rd to 22nd bits of the current value of x_{f}_mantissa are 10, the index is 010; when x_{f}_exp is −3, the index is 1; when x_{f}_exp is a value other than −1, −2, and −3, the index is 0.

Taking the fp32 system as an example, the decimal value 1.5 is represented as “1.1×2⁰” in binary form. The sign bit S is “0”. The actual exponential part exp is 0, and the exponential part represented by the system is a sum of the actual exponential part 0 and a fixed value 127, i.e., 127, which is represented as “01111111”. The mantissa part is 1.1, that is, 1.10000000000000000000000 (11 followed by 22 zeros). The rightmost bit 0 is the 0th bit, and the leftmost bit 1 (the 1 before the decimal point) is the 23rd bit (the most significant bit). Since the mantissa part is all in the form of 1.x in binary form, only the x part is recorded in the system, that is, it is recorded as 10000000000000000000000 (1 followed by 22 zeros) in the system.

In step 310, the exponential part of 1.5 is 0. Therefore, it is determined in step 310 to proceed with step 320, and step 320 is performed. Furthermore, after the determination in step 320, the process proceeds with step 330.

In step 330, the integer part xᵢₙₜ of 1.5 is the mantissa part of 1.5, i.e., mantissa [23:(23−exponential part)]=mantissa [23:(23−0)]=1. The mantissa part x_{f}_mantissa of the decimal part of the value 1.5 is the mantissa part of 1.5, i.e., mantissa<<exponential part of the value 1.5=mantissa<<exponential part (shifted left by 0 bits)=1.10000000000000000000000 (11 followed by 22 zeros).

In step 340, it is determined that x_{f}_mantissa is not 0. Therefore, step 350 is performed. After the determination in step 350, it is determined that the sign bit is not 1. Therefore, step 360 is performed.

In step 360, first the exponential part x_{f}_exp of the decimal part is set as 0. After that, the do-while loop is performed. In the loop, first x_{f}_exp is decreased by 1, and then tx_{f}_mantissa is shift left by 1 bit. Then, it is determined whether the 23rd bit of x_{f}_mantissa is 0. The loop exit condition of such a do-while loop is that the leftmost bit of x_{f}_mantissa is not 0 (i.e., 1). In fact, the process determines which section within the interval (0, 1) x_{f} itself belongs to. If x_{f} itself is greater than or equal to 0.5, that is, the leftmost bit (the 23rd bit) in the binary representation is 1, then the loop can be exited immediately after the first loop. By analogy, if x_{f} itself is greater than or equal to 0.25 but less than 0.5, it needs to exit the loop after the second loop, and so on. Meanwhile, x_{f}_exp in the loop records the base-2 order of x_{f} during the decrement.

Specifically, first, in the loop of step 360, x_{f}_exp is decreased from 0 by 1, that is, x_{f}_exp is updated as −1. x_{f}_mantissa is shifted left by 1 bit to obtain 100000000000000000000000 (1 followed by 23 zeros). After that, it is determined whether the 23rd bit of x_{f}_mantissa is 0. It can be understood that the 23rd bit of x_{f}_mantissa is 1, so the loop is exited and step 370 is performed.

In step 370, x_{f}_exp is −1, which conforms to the first case defined in step 370. The 23rd to 21st bits of the current value of x_{f}_mantissa, i.e., 100, is defined as the index directly. The index can correspond to the 5th sub-interval among the 8 sub-intervals (000, 001, 010, 011, 100, 101, 110, 111, that is, corresponding to 0-7 in decimal form) within the range (0, 1). After that, the corresponding parameters for constructing the approximation function can be searched for in the look-up table according to the index.

It can be understood that the functions and computation flows of the pre-processing module described above can have various variations. In the case of having other prior knowledge, for example, when it can be expected that the numerical values are distributed within a sub-interval (e.g., [0, ½)) of [0, 1), the pre-processing module 210 can adjust the quantized interval from [0, 1) to the expected sub-interval. In addition, the quantization of the interval may not be uniform as long as the quantization of the interval can meet the approximation of 2^{x}^{_{f}}.

Those skilled in the art can understand that according to the required representation precision or range, a circuit structure with sufficient precision or range can be selected, and there may be no overflow in this circuit structure. Therefore, in some representations, the pre-processing module 210 can operate with a processing mechanism for determining whether there is an overflow or underflow. In addition, in some other embodiments, it can be determined whether the data may overflow before the data is sent to the circuit 200. In this case, the pre-processing module 210 can also omit the overflow processing mechanism. Those skilled in the art can also understand that in some embodiments, it can be determined whether Xᵢ is 0 before it is sent to the circuit structure 200. In this case, the pre-processing module can omit the processing mechanism for determining whether Xᵢ is 0.

### Decimal Computation

Referring to FIG. 2, the decimal part x_{f} and/or information corresponding to the decimal part x_{f} (e.g., control signals such as “ctrl_signal” or an index) output by the pre-processing module 210 is further computed by the LUT 222 and the polynomial pipeline module 221 to output the approximation of 2^{x}^{_{f}}.

In this embodiment, the LUT module 222 includes multiple sets of predetermined parameters. Based on the input (e.g., the index), a set of parameters is selected from the predefined sets of predetermined parameters and is transmitted to the polynomial pipeline module 221. The polynomial pipeline module 221 constructs a polynomial function for the decimal part x_{f} using the selected set of parameters to obtain the approximation of 2^{x}^{_{f}}. In some embodiments, the LUT module 222 may be implemented as a hardware module where polynomial parameters are pre-stored as configuration values. In some embodiments, the circuit may support configurations for multiple approximation functions. For instance, the approximation function can be polynomials of varying orders, with the order configurable through registers and switchable via a network of switches.

It should be understood that polynomial function can be a 2^{nd} order polynomial function, a 3^{rd} order polynomial function, or a 4^{th} order polynomial function. Higher-order polynomials yield more precise approximations of 2^{x}^{_{f}}, but more storage in the LUT module 222 is required and the computational complexity increases. Furthermore, polynomial functions can take various forms, and their parameters may have different meanings. For example, a cubic polynomial can be represented as a α×x_{f}³+b×x_{f}²+c×x_{f}+d or alternatively as ((α+x_{f})×x_{f}+b)×x_{f}+c)×d. The multiple sets of predetermined parameters stored in the LUT 222 can represent the parameters of the polynomial functions, and their values may be pre-calculated and stored by technicians. Optionally, the format of the parameters matches the data format of the system in use, thus avoiding the need for format conversion.

Alternatively, the order of the polynomial function for the decimal part x_{f} in the polynomial pipeline module 221 is 2^{nd}, 3^{rd} or 4^{th}. The polynomial function for the decimal part x_{f} in the polynomial pipeline module 221 is a 3^{rd} order polynomial function as represented by the right-side polynomial function of Equation (3). Correspondingly, the LUT module 222 includes multiple sets of predetermined parameters. Each set of parameters consists of four values a, b, c, d, and is used to construct the polynomial function shown in Equation (3) to obtain the approximation of 2^{x}^{_{f}}. For example, for the interval [0, ⅛), when Equation (3) is used to obtain the approximation of 2^{x}^{_{f}}, the parameters are α=4.146572, b=11.9738, c=17.27442, d=0.05788906. Test results prove that the 3rd order polynomial function can achieve precise approximation of 2^{x}^{_{f}} while saving computational resources and storage space. Multiplications and additions in polynomial computation can be implemented using multipliers and adders, respectively.

$${2}^{{x}_{f}} ≅ ( ( a + {x}_{f} ) \times {x}_{f} + b ) \times {x}_{f} + c ) \times d \qquad ( 3 )$$

In some embodiments, the polynomial pipeline module 221 can receive control signals output by the pre-processing module 210. Since the control signals indicate expected computation results, the polynomial pipeline module 221 may bypass data processing. It should be understood that the control signals can also be transmitted to the LUT module 222 to indicate bypassing unnecessary computations.

Those skilled in the art can understood that the polynomial functions in the polynomial pipeline module 221 can take various forms beyond standard polynomial representations. The LUT module 222 may store a part of the parameters of the polynomial functions.

Those skilled in the art can understand that the approximate computation of 2^{x}^{_{f}} can be in various forms. In some embodiments, the approximation function may be predetermined by the designer, such as polynomial functions, exponential functions with other bases, etc.

Those skilled in the art can understand that in some embodiments, the approximation function of 2^{x}^{_{f}} may not be represented as a function of the decimal part x_{f}, but rather as a function of information corresponding to the decimal part x_{f}, such as a function related to encoding, etc.

Those skilled in the art can understand that as described above, there can be multiple variations in the specific structural arrangements among the polynomial pipeline module 221, the LUT module 222, and the pre-processing module 210, as long as there exists a direct or indirect coupling relationship among the preprocessing module 210, the polynomial pipeline module 221 and the LUT module 222, and the decimal part x_{f} and/or information corresponding to the decimal part x_{f} can be transmitted from the pre-processing module 210 to the polynomial pipeline module 221 and the LUT module 222.

### Post-Processing Module

The post-processing module 230 receives the integer part xᵢₙₜ from the pre-processing module 210, the approximation of 2^{x}^{_{f}}, and optionally control signals, from the polynomial pipeline module 221. After processing these inputs, the post-processing module 230 outputs an approximation of 2^{X}^{ᵢ}. Specifically, the post-processing module 230 performs the following operations including-adding the integer part xᵢₙₜ to the exponential part of the approximation of 2^{x}^{_{f}} to obtain the exponential part of the approximation of 2^{X}^{ᵢ}. Based on the separation of the input Xᵢ, the mantissa part of the approximation of 2^{x}^{_{f}} corresponding to the decimal part x_{f} is theoretically the same as the mantissa part of the approximation of 2^{X}^{ᵢ} in binary representation. Thus, the post-processing module 230 uses the mantissa part of the approximation of 2^{x}^{_{f}} as the mantissa part of the approximation of 2^{X}^{ᵢ}. It can be appreciated that, the approximation of 2^{X}^{ᵢ} is also in binary form.

In one embodiment, the post-processing module 230 performs the operations shown in FIG. 4. Firstly, the post-processing module 230 can receive a control signal sent from the post-processing module 210, and determine whether there is overflow or underflow and whether Xᵢ is 0. For example, as shown in Step 410, the post-processing module 230 first determines whether underflow exists. If underflow exists, meaning that the value of 2^{X}^{ᵢ} is very small and the expected output approaches zero, then output is set to zero as shown in Step 411. Similarly, as shown in Step 420, the post-processing module 230 determines whether overflow exists. If overflow exists, a predefined overflow value can be output. In some embodiments, as shown in Step 421, the output can be set to a specific value. For instance, in an fp32 system, a value indicating overflow can be configured as 32′b0 11111111 11111111111111111111111 or as an fp32 representation indicative of infinity, i.e., 32′b0 11111111 00000000000000000000000. Additionally, as shown in Step 430, the post-processing module 230 may determine whether Xᵢ is 0 based on the value of Zero_flag. If Xᵢ is 0, then in Step 431 1 can be output directly.

As shown in Step 440, the post-processing module 230 can set the output value to the approximation of 2^{x}^{_{f}} output by the polynomial pipeline module 221, i.e., the cubic polynomial result (“cubic_poly_result”) in some embodiments described above. Subsequently, as shown in Step 450, the integer part xᵢₙₜ is added to the exponential part of the output value, thereby the final output value is obtained.

It is understood by those skilled in the art that the processing sequence shown in FIG. 4 is illustrative, and the order of determining whether there is underflow or overflow, and whether Xᵢ is 0 can be rearranged as desired. It is also understood that, similar to the explanation of the polynomial pipeline module 221, depending on the required precision, the achievable precision of the circuit, and the presence of other pre-processing mechanisms, the post-processing module 230 may omit any of the mechanisms for handling underflow, overflow and Xᵢ=0 in some other embodiments.

It is also understood by those skilled in the art that FIG. 4 illustratively shows control signals being transmitted directly from the pre-processing module 210 to the post-processing module 230. In other embodiments, the control signals may be transmitted to the post-processing module 230 via the polynomial pipeline module 221 or the LUT module 222.

### Additional Processing

As described above, the Softmax computation can be approximated as shown in Equation (2), that is,

$${σ ( z )}_{i} = {2}^{{X}_{i}} / {\sum }_{j}^{K} {2}^{{X}_{j} .}$$

The circuit structures 100 and 200 provided in the above embodiments can achieve base-2 exponential computation, i.e., obtaining the numerator portion of the equation. Specifically, for a vector containing more than one element, each element of the vector can undergo base-2 exponential computation using the circuit structures 100 and 200. Once the base-2 exponential computation for each element of the vector is completed, the results of the computations for all the elements can be summed to obtain the denominator portion of Equation (2), thereby the result of Equation (2) is obtained. This method for accelerating the Softmax computation improves computational efficiency while maintaining accuracy. Simulation tests of the BERT model based on the fp32 format demonstrate that the accuracy of the results is virtually unaffected.

It is further understood by those skilled in the art that the computation of all the elements within the same vector can be implemented either simultaneously or sequentially.

In the above embodiments, the Softmax computation is a combination of base-2 exponential computation and other computations that can be approximated. The base-2 exponential computation can be accelerated by using the binary number-based computation acceleration circuit, improving computational efficiency while minimizing the loss of computational accuracy. The proposed computation acceleration circuit is particularly suitable for application scenarios in artificial intelligence processing of big data. In such scenarios where the volume of data and parameters is immense, the proposed computation acceleration circuit can improve computational efficiency while maintaining accuracy, and saving time, power and other resources.

It is understood by those skilled in the art that the circuit structure described above illustratively demonstrates a method of using polynomial functions to compute the approximation of 2^{x}^{_{f}}. In other embodiments, the circuit structure can use other functions to compute the approximation of 2^{x}^{_{f}}. The LUT module 122 can store predetermined parameters for constructing such alternative functions and select the parameters based on the decimal part x_{f} and/or information corresponding to the decimal part x_{f}, (e.g., an index).

It is further understood by those skilled in the art that the structural and functional relationships among the pre-processing module, the LUT module and function calculation module can vary as desired. In some embodiments, the LUT module may be part of the pre-processing module. In other embodiments, the LUT module may be part of the function calculation module. The pre-processing module sends the decimal part x_{f} to the LUT module within the function calculation module. Then the LUT module can generate an index based on the decimal part x_{f} and select parameters for constructing the function.

It should be noted that although various components or modules of the binary number-based computation acceleration circuit are detailed in the foregoing description, such divisions are merely exemplary and not mandatory. In practice, according to the embodiments of the present application, the features and functions of two or more modules described above can be implemented in a single module. Conversely, the features and functions of a single module described above can be further divided and implemented by multiple modules.

Persons skilled in the art can understand and implement other modifications to the disclosed embodiments by studying the description, disclosed content, drawings, and appended claims. In the claims, the wording “comprises” does not exclude other elements or steps, and the wording “a” or “an” does not exclude the plural. In practical applications of this disclosure, a single component may perform the functions of multiple technical features cited in the claims. Reference numerals in the claims should not be construed as limiting the scope.

1. A binary number-based computation acceleration circuit, comprising:
a pre-processing module for separating an input value Xᵢ into an integer part xᵢₙₜ and a decimal part x_{f};
a lookup table module and a function calculation module coupled to the pre-processing module, wherein the lookup table module is configured to receive the decimal part x_{f} and/or information corresponding to the decimal part x_{f}, and to select a set of parameters from predetermined parameters according to the decimal part x_{f} and/or the information corresponding to the decimal part x_{f}, and the function calculation module is configured to construct an approximation function using the set of parameters selected by the lookup table module to obtain an approximation of 2^{x}^{_{f}}; and
a post-processing module coupled to the pre-processing module and the function calculation module, wherein the post-processing module is configured to receive the integer part xᵢₙₜ from the pre-processing module, using a mantissa part of the approximation of 2^{x}^{_{f}} as a mantissa part of an approximation of 2^{X}^{ᵢ}, and using a sum of an exponential part of the approximation of 2^{x}^{_{f}} and the integer part xᵢₙₜ as an exponential part of the approximation of 2^{X}^{ᵢ};
wherein the input value Xᵢ, the approximation of 2^{x}^{_{f}} and the approximation of 2^{X}^{ᵢ} are represented in binary form.

2. The computation acceleration circuit of claim 1, wherein the pre-processing module is further configured to generate a quantized value of the decimal part x_{f}, and the information corresponding to the decimal part x_{f} is the quantized value.

3. The computation acceleration circuit of claim 2, wherein the quantized value is a 3-bit binary code or a 4-bit binary code.

4. The computation acceleration circuit of claim 1, wherein the pre-processing module is further configured to generate a first control signal according to an exponential part of the input value Xᵢ, and to send the first control signal to the post-processing module, wherein the first control signal indicates whether 2^{X}^{ᵢ} overflows or not.

5. The computation acceleration circuit of claim 1, wherein the pre-processing module is further configured to generate a second control signal according to the input value Xᵢ, and to send the second control signal to the post-processing module, wherein the second control signal indicates whether 2^{X}^{ᵢ} is 0 or not.

6. The computation acceleration circuit of claim 1, wherein the pre-processing module is further configured to determine the integer part xᵢₙₜ and the decimal part x_{f} according to a sign bit of the input value Xᵢ when the input value Xᵢ is within a range of (−1, 1).

7. The computation acceleration circuit of claim 1, wherein the pre-processing module is further configured to truncate a mantissa part of the input value Xᵢ according to an exponential part of the input value Xᵢ to obtain the integer part xᵢₙₜ when the input value Xᵢ is not within a range of (−1,1).

8. The computation acceleration circuit of claim 7, wherein the pre-processing module is further configured to truncate the mantissa part of the input value Xᵢ to obtain a value of a width equal to a sum of a width of the exponential part of the input value Xᵢ and 1 and starting from a highest bit of the mantissa part of the input value Xᵢ which is used as the integer part xᵢₙₜ.

9. The computation acceleration circuit of claim 1, wherein the pre-processing module is further configured to shift a mantissa part of the input value Xᵢ according to an exponential part of the input value Xᵢ to obtain the decimal part x_{f} when the input value Xᵢ is not within a range of (−1, 1).

10. The computation acceleration circuit of claim 9, wherein the pre-processing module is further configured to shift left the mantissa part of the input value Xᵢ for a width equal to that of an exponential part of the input value Xᵢ to obtain the mantissa part of the decimal part x_{f}, and to determine the decimal part x_{f} according to the mantissa part of the decimal part x_{f}.

11. The computation acceleration circuit of claim 10, wherein the pre-processing module is further configured to selectively reverse the integer part xᵢₙₜ according to a sign bit of the input value Xᵢ when the mantissa part of the decimal part x_{f} is equal to 0.

12. The computation acceleration circuit of claim 10, wherein the pre-processing module is further configured to selectively complement the integer part xᵢₙₜ and an exponential part of the decimal part x_{f} according to a sign bit of the input value Xᵢ when the mantissa part of the decimal part x_{f} is not equal to 0.

13. The computation acceleration circuit of claim 10, wherein the pre-processing module is further configured to perform the following steps:
Step 1: defining the exponential part of the decimal part x_{f} as 0;
Step 2: decreasing the exponential part of the decimal part x_{f} by 1, shifting left the mantissa part of the decimal part x_{f} by 1 bit, and determining whether a highest bit of the mantissa part of the decimal part x_{f} is 0;
Step 3: if it is determined that the highest bit of the mantissa part of the decimal part x_{f} is 0, repeating Step 2 until the highest bit of the mantissa part of the decimal part x_{f} is not 0; and
Step 4: using a value of the exponential part of the decimal part x_{f} when the highest bit of the mantissa part of the decimal part x_{f} is not 0 as a final value of the exponential part of the decimal part x_{f}.

14. The computation acceleration circuit of claim 13, wherein the pre-processing module is further configured to determine the information corresponding to the decimal part x_{f} according to the final value of the exponential part of the decimal part x_{f}.

15. The computation acceleration circuit of claim 1, wherein the function calculation module is a polynomial function, and the predetermined parameters of the lookup table module are parameters of the polynomial function.

16. The computation acceleration circuit of claim 15, wherein the polynomial function is a 2^{nd} order polynomial function, a 3^{rd} order polynomial function, or a 4^{th} order polynomial function.

17. The computation acceleration circuit of claim 1, wherein the computation acceleration circuit is used for accelerating normalized difference index Softmax computation.
